(19) United States
(12) Patent Application Publication
(10) Pub. No.: US 2020/0381733 A1
(43) Pub. Date: Dec. 3, 2020

(54) TITANIUM-BASED POSITIVE ELECTRODE MATERIALS FOR RECHARGEABLE CALCIUM BATTERIES AND CELL COMPRISING THE SAME

(71) Applicants: TOYOTA MOTOR EUROPE, Brussels (BE); AGENCIA ESTATAL CONSEJO SUPERIOR DE INVESTIGACIONES CIENTIFICAS, Madrid (ES)

(72) Inventors: Fanny BARDE, Brussels (BE); Maria Rosa PALACIN, Madrid (ES); Deyana STOYTCHEVA, Madrid (ES); Alexandre PONROUCH, Madrid (ES); Maria Elena ARROYO DE DOMPABLO, Madrid (ES); Neven BISKUP, Madrid (ES)

(73) Assignees: TOYOTA MOTOR EUROPE, Brussels (BE); AGENCIA ESTATAL CONSEJO SUPERIOR DE INVESTIGACIONES CIENTIFICAS, Madrid (ES)

(21) Appl. No.: 16/607,159

(22) PCT Filed: Jun. 9, 2017
(86) PCT No.: PCT/EP2017/064111

§ 371 Date: Oct. 22, 2019

(30) Foreign Application Priority Data
Apr. 27, 2017 (ES) P201700559

(51) Int. Cl. H01M 4/58; H01M 4/38; H01M 10/054

(52) U.S. Cl. CPC H01M 4/5815; H01M 10/0568; H01M 10/054; H01M 4/381

(57) ABSTRACT

The present invention relates to a calcium-based secondary cell comprising, as a positive-electrode active material, a titanium-based material comprising at least titanium (IV) and sulfide.

### FIELD OF INVENTION

The present invention relates to a calcium-based secondary cell with an operation temperature ranging from 30 to 150° C. comprising, as a positive-electrode active material, one or more titanium-based materials comprising at least titanium (IV) and sulfide being capable of accepting and releasing calcium ions.

### TECHNOLOGICAL BACKGROUND

Rechargeable electrochemical cells and batteries are a power source widely used in information-related devices, communication devices (such as personal computers, camcorders and cellular phones) as well as in the automobile industry or in stationary power generating devices. Conventional lithium-based cells typically include a positive electrode (also referred to as “cathode”) and a negative electrode (also referred to as “anode”) whose active materials are capable of accepting and releasing lithium ions, as well as an electrolyte arranged between the electrodes and including lithium ions.

Calcium (Ca) is much more abundant in nature than lithium (Li) and, despite the high atomic weight of Ca with respect to Li, the bivalent nature of Ca means that it could in principle provide a suitable rechargeable battery material with higher energy density, even if it has proven difficult so far to identify suitable chemistries and Ca batteries are very underdeveloped as compared to their Li counterparts.

Issues to be addressed in developing rechargeable Ca-based batteries include:
the capacities of some known rechargeable Ca-based batteries are relatively low;
if heated above 30° C., the electrolyte used may be subjected to decomposition in the presence of certain transition metal oxide materials typically used as positive electrode materials such as Co-based materials for example;
the operation voltages of some known rechargeable Ca-based batteries are relatively low;
the reduction of volume variations during cycling.

WO2016/050331 describes a calcium-based secondary cell comprising a negative electrode that includes: a negative-electrode active material, said negative-electrode active material being capable of accepting and releasing calcium ions; a positive electrode that includes a positive-electrode active material, said positive-electrode active material being capable of accepting and releasing calcium ions; an electrolyte arranged between the negative electrode and the positive electrode, said electrolyte comprising calcium ions and an electrolyte medium, wherein the electrolyte is not solid at standard conditions and wherein the electrolyte medium includes a non-aqueous solvent; and a temperature control element. This document mentions V₂O₅ as a possible positive-electrode active material intercalating and de-intercalating calcium ions reversibly. However, no experimental data using V₂O₅ as positive-electrode material is given. In addition, the theoretical capacity of this battery is relatively limited (295 mAh/g).

In M. Cabello et al., Electrochemistry Communications 67 (2016) 59-64, CaCo₂O₄ is proposed as a positive electrode material for Ca-based batteries using V₂O₅ as negative electrode. CaClO₄ in acetonitrile is used as electrolyte. The capacity and the operation voltage of these batteries are however relatively low. In addition, acetonitrile is highly flammable.

In the Ph.D. thesis of J. Rogosic entitled “Towards the Development of Calcium Ion Batteries” (MIT, 2014), V₂O₅, FeS₂ and Mo₃Se₄ Chevrel phases are reported as possible positive electrode materials. The Chevrel phase is reported as the most promising material. In such a case the initial de-intercalated material has a molar mass of 600.84 g/mol. Tests are performed in a cell with the following configuration: CaHg₁₁—CaHg/acetonitrile+Ca(ClO₄)₂/positive materials. The capacities (mAh/g-active positive material) achieved in this prior art are extremely low because the positive and negative materials reported have high molar weight. Also non-environmentally friendly mercury is contained. In addition, acetonitrile is highly flammable.

In M. Hayashi et al., Journal of Power Sources 11.9-121 (2003) 617-620, V₂O₅ or V₂O₅—P₂O₅ are reported as possible host materials for calcium ions. The accommodation of calcium ions in the V₂O₅ structure takes place around −1 V vs. Ag⁺/Ag pseudo reference. The cell configuration is Ca/electrolyte+Ca(ClO₄)₂/V₂O₅. Re-chargeability for 1 cycle is apparently observed in this system and a new phase was formed during discharge. The theoretical capacity of these batteries is however relatively limited (295 mAh/g), and the experimental capacity exceed by far the theoretical one (400 mAh/g) indicating that some side reactions are taking place.

In A. L. Lipson et al., Chemistry of Materials, 2015, 27 (24), pp. 8442-8447, manganese hexacyanoferrate (MFCN) is reported as positive electrode material and CaSn as negative electrode material. The capacity and full cell voltage of the batteries achieved in this prior art are relatively low.

KR20150142786 proposes a Ca-based battery comprising a negative electrode material formed by mixing a TiS₂ material, a conducting agent and a binder to absorb/release Ca; an electrolyte formed by mixing a calcium salt, propylene carbonate (PC) and dimethyl carbonate (DMC), wherein a binding structure of a calcium ion and PC is changed to provide a rechargeable Ca-based battery in which calcium ions are absorbed/released through a TiS₂ interlayer. If a full battery using TiS₂ material as negative electrode and CaCoO as positive electrode, as described in KR20150142786, would have been assembled—which seems quite unrealistic as a CaCoO material does not exist—this hypothetic battery would be in a discharge state, meaning that it will need to be charged before to be used, representing a disadvantage in terms of practicality and cost. In addition, this battery would hypothetically provide a voltage lower than 1 V.

### SUMMARY OF THE INVENTION

The present invention, in one aspect, relates to a non-aqueous calcium-based secondary cell comprising:
a negative electrode that includes a negative-electrode active material, said negative-electrode active material being capable of accepting and releasing calcium ions,
a positive electrode that includes a positive-electrode active material, said positive-electrode active material being capable of accepting and releasing calcium ions,
an electrolyte arranged between the negative electrode and the positive electrode, said electrolyte comprising calcium ions dissolved in at least one solvent,
a temperature control element able to set the operating temperature of the cell from 30 to 150° C.,

wherein the positive-electrode active material is one or more titanium-based materials comprising at least titanium (IV) and sulfide.

In another aspect, the invention relates to a method for operating a calcium-based secondary cell according to the invention.

The invention also relates to a non-aqueous calcium-based secondary battery comprising such a calcium-based secondary cell, and further to a vehicle, an electronic device or a stationary power generating device comprising such a non-aqueous calcium-based secondary battery.

Finally, the invention also relates to a vehicle, an electronic device or a stationary power generating device comprising a non-aqueous calcium-based secondary battery according to the invention.

### BRIEF DESCRIPTION OF THE FIGURES

FIG. 1 is a schematic view of a calcium-based secondary battery of the present invention, during the discharge (FIG. 1a) and charge (FIG. 1b) processes.

FIG. 2 shows the various crystal structures of intercalated layered chalcogenides CaₓTiS₂. In the color code, sulfide atoms (S) are the smallest black spheres, titanium atoms (Ti) are in light grey, and calcium atom (Ca) alone or calcium atom (Ca) and solvent molecules (L) are in darker grey.

FIG. 3 shows the calculated average voltage for different structures of CaₓTiS₂.

FIG. 4 shows the calculated energy barrier (FIG. 4a) and analysis of the paths for Ca diffusion in Ca_{1/18}TiS₂ with O1 structure (FIG. 4b).

FIG. 5 shows the discharge (FIG. 5a) and charge (FIG. 5b) of a full Ca/TiS₂ cell cycled at 100° C. at a rate of C/100 in 0.45M Ca(BF₄)₂ in EC:PC electrolyte.

FIG. 6 shows X-Ray Diffraction analysis of the positive electrode of the Ca/TiS₂ full cell as prepared, after discharged at 100° C. and after recharge at 100° C. Pristine corresponds to the electrode as prepared.

FIG. 7 shows the 1^{st} cycle (charge and discharge) of Ca/TiS₂ already shown in FIG. 5 and of comparative example 1 (in dotted lines) where a full Ca/V₂O₅ cell was cycled at 100° C. at a rate of C/100 in 0.45M Ca(BF₄)₂ in EC:PC electrolyte. V₂O₅ is used as a benchmark tested in the same conditions as TiS₂ in order to demonstrate the advantages of the cell of the invention in terms of higher experimental capacity, and better rechargeability.

### DETAILED DISCLOSURE OF THE INVENTION

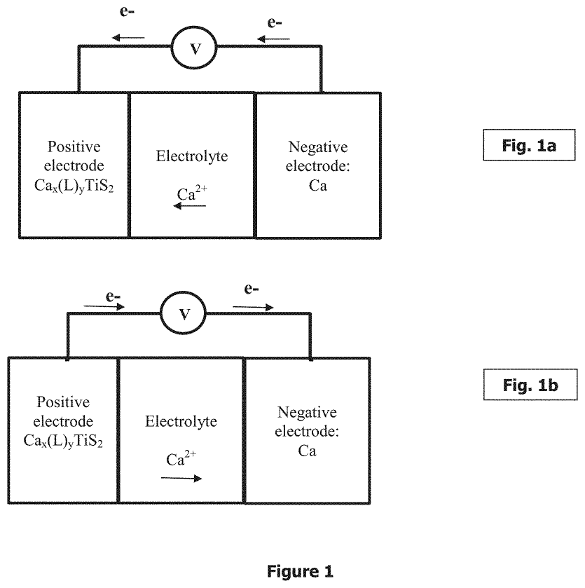

The invention proposes titanium-based materials suitable as positive electrode materials for use in a rechargeable multivalent battery. The multivalent element is the divalent Ca²⁺. The operation principle of the battery involves reaction of the positive electrode materials with calcium ions (as shown in FIG. 1).

Generally, the Ca-based battery, schematically described in FIG. 1 contains a positive electrode containing the positive electrode materials described in the present invention; a separator typically impregnated with a non-aqueous electrolyte or a gel polymer membrane containing calcium ions; and a negative electrode. Both positive and negative electrodes are commonly connected to current collectors. In the case of the anode, Ca can be used as both negative electrode material and current collector. All parts are fitted together in a battery casing which can have any shape. Commonly prismatic or cylindrical shapes will be preferred. The battery casing may be surrounded by some thermal components which could help the battery reach a certain working temperature.

Suitable positive electrode materials in the present invention include one or more titanium-based materials comprising at least titanium (IV) and sulfide.

Mixtures of one or more materials of general formulae CaₓL_{y}TiS₂, wherein:
0≤x≤1,
0≤y≤6, and preferably y=0,
L is a solvent molecule issued form the solvent(s) present in the cell, preferably chosen from ethylene carbonate (EC), propylene carbonate (PC), dimethyl carbonate (DMC), butylene carbonate (BC), vinylene carbonate (VC), fluoroethylenecarbonate (FEC), vinylene carbonate (VC), and fluoroethylenecarbonate (FEC), and more preferably chosen from ethylene carbonate (EC), propylene carbonate (PC), and dimethyl carbonate (DMC),

for use as positive-electrode active materials, also constitute a preferred embodiment in the framework of the present invention.

In this case, the titanium-based material of general formula CaₓL_{y}TiS₂ advantageously comprises calcium species CaₓL_{y} intercalated within the TiS₂ material.

Mixtures of one or more materials of general formulae CaₓTiS₂ wherein 0≤x≤1, for use as positive-electrode active materials, constitute a more preferred embodiment in the framework of the present invention. In this case, the titanium-based material of general formula CaₓTiS₂ advantageously comprises calcium species Caₓ intercalated within the TiS₂ material.

A material of general formulae TiS₂, for its use as positive-electrode active materials, constitutes an even more preferred embodiment in the framework of the present invention.

The anticipated reactions occurring at the positive electrode for CaₓL_{y}TiS₂ materials are as follows:
during the cell discharge, two types of reaction may occur as follows:

TiS₂+xCa²⁺+2x e⁻→CaₓTiS₂ Reaction (1):

[x(Ca²⁺)+yL]+TiS₂+2x e⁻→CaₓL_{y}TiS₂ Reaction (2):
where the TiS₂ material is able to host both Ca²⁺ alone or Ca²⁺ and L solvent molecule together,
during the cell charge, two types of reaction may occur as follows:

CaₓTiS₂→TiS₂+xCa²⁺+2x e⁻ Reaction (3):

CaₓL_{y}TiS₂→TiS₂+xCa²⁺+2x e⁻+yL Reaction (4):

Suitable positive-electrode active materials in the present invention may have a O1 structure, O3 structure, P3 structure, or a mixture of these structures. The O or P letter describes the alkali ion site (octahedral or prismatic, respectively) and the number 1 or 3 indicates the number of slabs within the hexagonal cell. The O3 structure has a ABC stacking of 3 layers. The P3 structure has a ACCB sequence. In the case of Li⁺ intercalation, C. Delmas et al, Mat. Res. Bull., Vol. 11, pp. 1081-1086, 1976, have shown that the structural changes among these structures observed during the electrochemical intercalation/de-intercalation reactions can be explained in a rather simple way: no structural modification occurs within the sheets (the temperature is too low to allow the internal Ti—S bonds to break), but the sheets may glide with respect to each other. The factors that determine the type of structure (O3, P3, etc.) in the layered chalcogenides depends on the size and charge of the ions A, as well as on the degree of interaction. The ions A are intercalated in this model allowing the formation of a AxTiS₂ material (A=Li, Na, K, Rb and Cs).

The positive-electrode active material of the invention is advantageously a titanium-based material selected from the group consisting of: TiS₂ (O1 structure), CaTiS₂ (O3 structure), CaₓTiS₂ wherein 0<x<1 (P3 structure), and mixtures thereof.

In the context of titanium-based materials suitable as positive-electrode active materials in the present invention, metal impurity such as Ti metal in the materials up to 10 wt %, preferentially up to 5 wt %, may be accepted.

It is considered that titanium-based materials used in the present invention may generally be electrochemically active in presence of Ca²⁺ which means that they change oxidation state while Ca²⁺ is accommodated in their structure delivering current; and vice versa. These species may generally have a theoretical capacity above 300 mAh/g-active material, for example a theoretical capacity of 478 mAh/g for TiS₂.

It is considered that such species may generally be used preferentially in combination with Ca metal anode (instead of V₂O₅ anode for example), the theoretical capacity of Ca metal being bigger than to the one of V₂O₅ and still giving an average theoretical battery operation voltage of approximately 1.7 V.

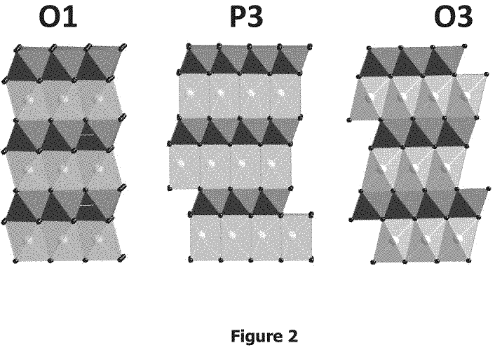

Embodiments of the present invention may present one of more of the following advantages:
the energy density of rechargeable calcium-based batteries of the present invention may be theoretically higher than that of the current commercial secondary Li-ion batteries, and higher than the calcium-based battery reported in previous art,
the electrolyte may be stable in the presence of a positive-electrode active material as described in the present invention even if the battery reaches temperatures above 40° C.,
no environmentally unfriendly materials such as heavy metals (including mercury) are needed,
compared to certain prior art calcium-based batteries, Ca batteries described in the present invention work at moderate temperatures (lower than 150° C.),
Ca batteries described in the present invention show improved capacities compared to those reported in the prior art,
Ca batteries described in the present invention show higher operation voltage compared to those reported in the prior art,
positive-electrode active materials of the present invention present good electronic conductivity, and
positive-electrode active materials used in the present invention present moderate volume changes (less than 15%) between intercalation and de-intercalation of calcium ions, a factor which supports the long term cyclability (see FIG. 2 in this respect).

In a preferred embodiment, the titanium-based material of the invention presents an activation energy for calcium ions migration of around 0.8 eV, and an estimated diffusion coefficient for calcium ions that is higher than 10⁻¹⁷ cm²·s⁻¹ at room temperature (25° C.).

In cells of the present invention, the negative electrode may be a calcium metal anode or a calcium alloy anode, and preferably a calcium metal anode. The alloy may have the following formula: CaₘB wherein: m is 0≤m≤3, and B is a metal or a semi-conductor element. The negative electrode may include Ca metal, or Ca-alloys such as CaₓSn_{y} or CaₓSi_{y} where preferentially 0≤x≤2.

The negative electrode may be for example a foil of metallic calcium. In this case, the metallic calcium may also play the role of current collector. A pre-formed, metallic calcium-containing negative electrode can thus be used during assembly of a calcium-based secondary electrochemical cell.

The negative electrode may include a support, such as a current collector, having a metallic calcium coating as negative-electrode active material. The coating is obtainable by depositing metallic calcium on the collector. The coating may be present on part of the support only or on the entire support.

The collector may be in the form of a foil, foam or grid. The collector may comprise or consist of copper, aluminum, stainless steel, nickel, gold, platinum, palladium, titanium or carbon. For example, the collector may comprise or consist of one or more of copper, aluminum, stainless steel, nickel, gold, platinum and palladium. Alternatively, the collector may include or consist of carbon for example type carbon paper. Copper, stainless steel, nickel and carbon, notably carbon and stainless steel, are cost-effective options. Use of gold or aluminum presents advantages in that these materials exhibit the lowest lattice mismatch with calcium. Carbon and aluminum present the advantage of being lighter.

Techniques are known to deposit metallic calcium on a support such as a collector. Electrochemical deposition is a possibility. In situ deposition of metallic calcium on a support previously added during cell assembly is a possibility. In situ deposition may take place while the cell is in use or in charge. Pulsed Laser Deposition and Radio Frequency sputtering are other options. In this case, a target of pure calcium metal may be used. This target is commercially available for example from American Elements. Nickel foams or grids (on which metallic calcium may be deposited) are also commercially available from Goodfellow. Foams or grids made of copper or aluminum as well as carbon foams (one possible supplier of aluminum, copper or carbon foams is ERG Materials & Aerospace Corporation) or carbon paper (one possible supplier of carbon paper is Toray), as foils or grids are also commercially available.

Use of a pre-formed, metallic calcium-containing negative electrode and metallic calcium deposition (e.g. in situ deposition) are not mutually exclusive options. If desired, metallic calcium deposition may be performed on a current collector already made of metallic calcium.

In a cell or battery according to the present invention, an electrolyte is arranged between the negative electrode and the positive electrode. In the electrolyte, calcium ions may be in the form of a calcium salt, for example an inorganic calcium salt and/or an organic calcium salt. Preferably, the salt is anhydrous. The salt may be selected from the group consisting of calcium tetrafluoroborate (Ca(BF₄)₂), calcium perchlorate (Ca(ClO₄)₂) calcium hexafluorophosphate (Ca(PF₆)₂), calcium tetrafluorosulfonylimide Ca(TFSI)₂, calcium triflate Ca(Tf)₂, Ca(CF₃SO₃)₂ and mixtures thereof. Ca(BF₄)₂, Ca(ClO₄)₂, Ca(PF₆)₂, Ca(TFSI)₂, and mixtures thereof, may be preferred. Ca(BF₄)₂ is particularly preferred, in particular when the titanium-based material is CaₓTiS₂.

The salt may be dissolved in the electrolyte medium. The salt may be present in an amount comprised between 0.05M and 2M, such as between 0.1M and 1M, with respect to the volume of the electrolyte.

The electrolyte may be substantially free of other metal ions of Group I and II of the period table—for example lithium ions, sodium ions, potassium ions. This means that the amount of metal ions other than calcium possibly presents in the electrolyte is electrochemically ineffective.

Each solvent present in the medium is substantially free of water. Unless otherwise indicated, substantially free of water means that the solvent may include water in an amount equal to or lower than 300 ppm, such as equal to or lower than 50 ppm, as measured with the Karl Fischer titration technique.

Advantageously, each solvent present in the medium and/or the combination thereof is stable at a temperature between at least −30 and 150° C. (stability window).

Each solvent present in the medium may independently be selected from the group consisting of cyclic carbonates, linear carbonates, cyclic esters, cyclic ethers, linear ethers, and mixtures thereof.

Cyclic carbonates may be selected from the group consisting of ethylene carbonate (EC), propylene carbonate (PC), butylene carbonate (BC), vinylene carbonate (VC), fluoroethylenecarbonate (FEC), and mixtures thereof.

Linear carbonates may be selected from the group consisting of dimethyl carbonate (DMC), diethylcarbonate (DEC), ethyl methyl carbonate (EMC), and mixtures thereof.

Cyclic ester carbonates may be γ-buryrolactone and/or γ-valerolactone.

Cyclic ethers may be tetrahydrofuran (THF) and/or 2-methyltetrahydrofuran.

Linear ethers may be selected from the group consisting of dimethoxyethane (DME), ethylene glycol dimethyl ether, triethylene glycol dimethyl ether (TEDGE), tetraethyleneglycol dimethyl ether (TEDGE), and mixtures thereof.

In addition or in alternative, the solvent may include dimethylsulfoxide (DMSO) or nitrile solvents (such as propionitrile and 3-methoxypropionitrile).

Preferably, the electrolyte contains at least two solvents, one of them being ethylene carbonate (EC). For example, the electrolyte medium may include ethylene carbonate (EC) and propylene carbonate (PC), such as a combination of formula ECₕ:PC₁₋ₕ wherein the ratio is expressed as volume:volume and h is 0≤h≤1, such as 0.2≤h≤0.8 or h is 0.5. Mixtures of ethylene carbonate (EC) and propylene carbonate (PC) may be stable between −90° C. and 240° C. The solvent may be, for example, a combination of ethylene carbonate (EC), propylene carbonate (PC) and dimethyl carbonate (DMC), such as a combination having formula ECₓ:PC_{y}:DMC_{z} wherein the ratio is expressed as volume:volume and 0≤x, y , z≤1 and x+y+z=1.

The at least two solvents may be present in a total (i.e. combined) amount comprised between about 50 and 99 wt %, with respect to 100 wt % of the electrolyte. For example, the solvents may be present in an amount comprised between about 70 and 99 wt %, with respect to 100 wt % of the electrolyte. This range is preferred for having liquid electrolytes. When the electrolyte medium further includes a polymer—such as a gelling polymer—the solvents are advantageously present in an amount comprised between about 50 and 70 wt %, with respect to 100 wt % of the electrolyte. This range is preferred for having gel polymer electrolytes.

In preferred embodiments of the present invention, the electrolyte will contain Ca(BF₄)₂ in ethylene carbonate (EC):propylene carbonate (PC). Here a concentration of around 0.45M of Ca(BF₄)₂ will generally be appropriate.

The electrolyte medium may further include a component (such as a crown ether) that facilitates calcium salt dissociation and/or enhances calcium salts dissolution.

The electrolyte medium may further include a gelling polymer. This is typically the case of gel polymer electrolytes.

The gelling polymer may be selected from the group consisting of polyethylene oxide (PEO), polyvinylidene fluoride (PVDF), polyacrylonitrile (PAN), polymethyl methacrylate (PMMA), poly(vinyl) chloride (PVC), and mixtures thereof.

When the electrolyte medium contains a gelling polymer as defined above, it may further comprise a filler, the filler including:
a component which can be crosslinked and/or thermoset, for example to improve the electrolyte mechanical properties,
a plasticizer, for example to improve the electrolyte ionic conductivity,
nanoparticles/nanoceramics, and/or
a component (such as a crown ether) that facilitates calcium salt dissociation and/or enhances calcium salt dissolution.

Nanoparticles/nanoceramics may include Al₂O₃, SiO₂, ZrO₂, MgO, and/or CeO₂ and may have an average particle size equal to or lower than about 15 nm (this value can be measured by methods disclosed above). This component may be added to increase the electrolyte conductivity. Suitable Al₂O₃ nanoparticles having an average particle size of 5.8 nm are commercially available from Aldrich Research Grade. Suitable SiO₂ nanoparticles having an average particle size of 7.0 nm are commercially available from Aldrich Research Grade.

The filler may be present in an amount of lower than 10 wt % with respect to the weight of the total gel polymer electrolyte.

As mentioned above, Ca—Si alloys may be used in negative electrode materials of the invention. Ca—Sn alloys are also candidates.

In the present invention, the positive-electrode active material containing a titanium-based material may be formulated as a part or the whole of a powder composite positive electrode, using processing techniques as described hereinafter.

In the present invention, the positive electrode may be prepared as a powder composite positive electrode. This electrode is obtainable by processing, such as compressing, a mixture (a) including:
component (a1) which is the positive-electrode active material, and
component (a2) which displays electronic conducting properties and/or electrode volume change constraining properties.

Obtaining mixture (a) may be performed by common techniques. For example, mixture (a) can be obtained by simply mixing the various components, for example by means of planetary mills (such as ball miller commercially available from Fritsch).

Component (a1) may be used in an amount comprised between about 50% and about 100%, preferably between about 65% and about 95%, such as between about 70% and about 90%, for example about 75%, with respect to the weight of mixture (a). Component (a2) may be used in an amount comprised between about 0% and about 40%, preferably between about 10% and about 30%, for example 25% with respect to the weight of mixture (a).

The properties of component (a2) are thought to be useful when the positive electrode is in use.

The positive electrode may be a composite film positive electrode. This electrode is obtainable by processing a slurry (b) including:
component (b1) which is the positive electrode active material,
component (b2) which displays electronic conducting properties and/or electrode volume change constraining properties,
component (b3) which is a binder,
component (b4) which is a solvent.

Component (b1) may be used in an amount comprised between about 50% and 90% with respect to the combined weight of components (b1) to (b3), i.e. the solid content of slurry (b).

Component (b2) may be used in an amount comprised between about 5% and 30% with respect to the combined weight of components (b1) to (b3).

Component (b3) may be used in an amount comprised between about 5% and 25% with respect to the combined weight of components (b1) to (b3).

Component (b4) may be used in any amount suitable to impart a workable viscosity to the slurry. For example, it may be used in an amount of about 500% with respect to the combined weight of components (b1) to (b3).

Slurry (b) may further comprise components commonly used in electrode manufacturing such as component (b5) suitable to impart self-standing properties to the positive electrode.

Components (a1) and (b1) may be in the form of particles having an average particle size falling in the range of 0.01 to 100 microns, such as in the range of 0.15 to 50 microns. Average particle size may be either communicated by particles supplier, or measured by e.g. SEM (scanning electron microscopy), TEM (transmission electron microscopy) or laser granulometry techniques.

In the context of slurry (b), component (b2) can typically facilitate slurry preparation and deposition. Components (a2) and (b2) may comprise, such as consist of particulate carbon. Particulate carbon may be selected within one or more of carbon black such as ketjen black, acetylene black, channel black, furnace black, lamp black, and thermal black; graphite, such as natural graphite, e.g., scaly graphite, artificial graphite, and expanded graphite; activated carbon from charcoal and coal; carbon fibers obtained by carbonizing synthetic fibers and petroleum pitch-based materials; carbon nanofibers; tubular carbon, such as carbon nanotubes; and graphene. A suitable conductive carbon black is Carbon Super P® commercially available from TIMCAL. The main characteristics of Super P® are their high purity, high structure and their moderate surface area. The high purity is evidenced by the low ash, moisture, sulfur and volatile contents, while their high structure is expressed by oil absorption and electrical conductivity. Super P® conductive carbon black is a carbon black with a high to very high void volume originating from the interstices between the carbon black particle due to its complex arrangement and porosity, in a particular structure. Such a structure allows retention of a conductive carbon network at low to very low carbon content in the electrode mix. Super P® is a material with no, or nearly no sieve residue on the 325 mesh sieve.

Component (b3) is typically used to ensure the cohesion of the positive electrode components. Component (b3) may comprise, such as consist of a thermoplastic and/or a thermosetting resin. Component (b3) may be selected from the group consisting of polyethylene, polypropylene, polytetrafluoroethylene (PTFE), polyvinylidene fluoride (PVDF), styrene-butadiene rubber (SBR), carboxymethylcellulose (CMC) or salts thereof showing various molecular weights and mixtures thereof. For example, component (b3) may be a combination of CMC and SBR.

Component (b3) may also be selected from the group consisting of tetrafluoroethylene-hexafluoropropylene copolymers, tetrafluoroethylenehexafluoropropylene copolymers (FEP), tetrafluoroethylene-perfluoroalkyl vinyl ether copolymers (PFA), vinylidene fluoride-hexafluoropropylene copolymers, vinylidene, fluoride-chlorotrifluoroethylene copolymers, ethylenetetrafluoroethylene copolymers (ETFE resins), polychlorotrifluoroethylene (PCTFE), vinylidene fluoride-pentafluoropropylene copolymers, propylene-tetrafluoroethylene copolymers, ethylene-chlorotrifluoroethylene copolymers (ECTFE), vinylidene fluoride-hexafluoropropylene-tetrafluoroethylene copolymers, vinylidene fluoride-perfluoromethyl vinyl ether-tetrafluoroethylene copolymers, ethylene-acrylic acid copolymers, and mixtures thereof.

Component (b3) may also include a copolymer having sulfonate group-terminated perfluorovinyl ether groups attached to a poly(tetrafluoroethylene) backbone. An example is copolymers commercially available under the name Nafion®. For example, the copolymer may be a dispersion of a copolymer having sulfonate group-terminated perfluorovinyl ether groups attached to a poly(tetrafluoroethylene) backbone in a mixture of water and 20 wt % of alcohol. This product is commercially available under trademark LIQUION™ from Ion Power Inc.

Component (b4) is typically used to impart a viscous aspect to slurry (b). Component (b4) may be a solvent selected from the group consisting of acetone, alcohols such as ethanol, cyclic aliphatic hydrocarbon compounds such as cyclohexane, N-methyl-2-pyrrolidone (NMP), propylene carbonate (PC), N,N-dimethylformamide, tetrahydrofuran (THF), water, and mixtures thereof.

An example of component (b5) is a plasticizer such as any one or more of polyethylene glycol (PEG) and dibutylphtalate (DBP).

Obtaining slurry (b) may be performed by common techniques. For example slurry (b) can be obtained by dispersing solid components (e.g. components (b1) to (b3)) in component (b4), for example by means of a high-performance disperser (such as dispersers available from IKA) or an ultrasonic disperser (such as dispersers available from Hielscher) or/and by means of a centrifugal mixer (such as commercially available from Thinky). WO 2013/139370 discloses for example a method for manufacturing a slurry by suspending particulate carbon, a binder and optionally a catalyst in a solvent.

A composite film positive electrode as defined above (whether self-standing or supported) may be manufactured by a method comprising a step i) of depositing the positive electrode active material, e.g. in the form of a slurry (b), on a support.

Depositing may be casting or impregnating, as appropriate depending e.g. on the desired structure of the electrode (self-standing or supported on a current collector and, in this latter case, the type of current collectors used).

Casting may be performed by the Doctor Blade method, which allows a fine control of the thickness of the active material deposited layer. For casting, the support may be in the form of a foil. For casting, the support may be made of e.g. copper, aluminum, stainless steel, nickel, gold, platinum, palladium, titanium or carbon if it is a current collector or e.g. glass or Teflon® for self-standing electrodes.

Impregnating may be performed as disclosed in WO 2013/139370. Typically, impregnating is chosen when the support is a current collector in the form of a foam.

When the positive electrode is designed to be a self-standing one, such as a self-standing film positive electrode, the method may further comprise a step ii-1) of drying the active material deposited on the support and a subsequent step iii-1) of removing, for example peeling off, the support.

Alternatively, the method may further comprise a step ii-2) of drying the active material, deposited on the support and a subsequent step iii-2) of further processing the product obtained in step ii-2). This embodiment is suitable to obtain positive electrodes in which the support is a current collector as defined above, and hence it is part of the final positive electrode. Further processing in step iii-2) may include a step of heat treating the product of step ii-2). Typically, heat treating is performed at a temperature lower than the melting temperature of the alloy(s) contained in the active material.

Further processing in step iii-2) may include a step of cutting and/or pressing the optionally heat-treated product of step ii-2). Typically, pressing is performed under a pressure between 10⁷ to 10⁹ Pa. Cutting and pressing may be performed in any order.

When preparing a powder electrode mixture for the present invention, Ti-based materials may be prepared to which an electronic conductor (such as carbon, or metal particles) is added. Similarly, the positive-electrode active material containing a titanium-based material may also be formulated as a part or the whole of a composite film positive electrode, using processing techniques as described above. Thus, a slurry may be prepared containing one or more of the above-described Ti-based materials, an electronic conductor (such as carbon, or metal particles) and/or a binder (such as PVDF, PTFE, CMC, Nafion®). The resulting slurry may be coated on a current collector in the form of a foil (Al foil) or in the form of foam (such as Al foam, carbon foam), or in form of a porous membrane (such as carbon paper).

In a calcium-based secondary cell according to the invention, in the dry weight of the powder mixture or slurry composition used to form a positive-electrode active layer/coat a conducting electrode surface (such as a metal foil), the positive-electrode active material which is one or more titanium-based materials comprising at least titanium (IV) and sulfide, may appropriately constitute at least 50 wt %, such as at least 60 wt %, at least 70 wt %, at least 80 wt %, or at least 90 wt % of the total dry weight of the powder mixture or slurry composition, the remainder typically comprising, notably, conductive components such as carbon-based materials and binders such as polymer binders.

Advantageously, the cell of the present invention may further comprise a temperature control element. For example, the temperature control element may not be physically part of (e.g. an integral part of) the cell but they may be configured to interact. The temperature control element may be configured to provide heating functionality and/or cooling functionality, e.g. depending on whether the cell is used in a context—such as a fuel engine—wherein a heat source is already present. An element configured to provide at least cooling functionality may be advantageous when considering the unavoidable self-heating of the cell when in use due to the Joule effect. Alternatively, the temperature control element may be configured to provide instructions to heating and/or cooling elements present with the cell. Background information on possible technical solutions to pre-heat high-voltage battery packs in hybrid electric vehicles up to room temperature (i.e. 25° C.) can be found for example in A. Pesaran et al. “Cooling and Preheating of Batteries in Hybrid Electric Vehicles”, The 6^{th} ASME-JSME Thermal Engineering Joint Conference, Mar. 16-20, 2003, TED-AJ03-633.

The temperature control element is configured to bring and/or maintain the cell at a temperature between about 30° C. and 150° C., such as between about 50° C. and 110° C., which was found to be particularly effective for operating the cell presently disclosed. More preferred temperature ranges of operation are between 60° C. and 80° C., more preferably between 70° C. and 80° C., and most preferably around 75° C. Although it is not intended to be bound by any theory, it is believed that at this temperature an appropriate conductivity of the SEI (solid-electrolyte interphase) can be achieved and/or an improved ion-pairing would occur, in any of the above mentioned cases improving the battery performances. Accordingly, if the cell is operated in an environment characterized by low temperatures (such as a device or a vehicle exposed to winter temperatures), the temperature control element is suitably provided and/or coupled with heating means (for example pre-heating means), such as a resistance heater and/or a heat pump, so as to bring the cell to desired operating temperature. The temperature control element may also be provided with cooling means, for example a fan configured to blow forced air and/or a refrigeration unit configured to operate a refrigeration cycle, so as to maintain the cell within a suitable window of operating temperatures in case the device of the vehicle is provided with a heat source such as a fuel engine or the cell, power inverter, or other devices nearby generate heat.

According to some embodiments, the temperature control element may include cooling means only for those applications intended to be consistently exposed to temperatures above about 30° C. The temperature control element may be an integral cell thermal management device including both a heating and a cooling means. The device may be operated in a controlled manner by e.g. a computer-assisted device (also possibly part of the temperature control element) so as to reach and maintain an appropriate operating temperature depending on the ambient conditions.

The cell may further comprise a separator. The separator may be a porous film or a non-woven fabric. For example, the separator may comprise polyethylene, polypropylene, cellulose, polyvinylidene fluoride, glass ceramics, or mixtures thereof. The separator may contain the electrolyte. A secondary cell incorporating this embodiment may be obtainable by contacting, e.g. impregnating, the separator with a liquid electrolyte.

The secondary cell may have any form, such as prismatic or cylindrical form.

In another aspect, the invention relates to a method for operating a calcium-based secondary cell according to the invention.

The method of the invention preferably comprises a step of setting cell operating temperature from 30° C. to 150° C. Advantageously, the step of setting cell operating temperature comprises a temperature control element.

The method of the invention may also comprise the step of applying a voltage from about 0.6 to about 2.5 V, for intercalating calcium ions in the titanium-based material.

In one aspect, the present invention also concerns a non-aqueous calcium-based secondary battery comprising a calcium-based secondary cell as defined above, for example a plurality of calcium-based secondary cells wherein at least one is a calcium-based secondary cell as defined above or a plurality of calcium-based secondary cells each independently being as defined above. The battery may include one or more secondary cells as defined above, and a casing. The casing may be surrounded by a temperature control element as defined above, in case this element is present.

In one aspect, the present invention also concerns a vehicle, such as a motor vehicle, comprising a non-aqueous calcium-based secondary battery as defined above.

In one aspect, the present disclosure discloses an electronic device, such as an information-related device or a communication device (for example a personal computer, camcorder or cellular phone), comprising a non-aqueous calcium-based secondary battery as defined above.

In one aspect, the present disclosure discloses a stationary power generating device comprising a non-aqueous calcium-based secondary battery as defined above.

Within the practice of the present invention, it may be envisaged to combine any features or embodiments which have hereinabove been separately set out and indicated to be advantageous, preferable, appropriate or otherwise generally applicable in the practice of the invention. The present description should be considered to include all such combinations of features or embodiments described herein unless such combinations are said herein to be mutually exclusive or are clearly understood in context to be mutually exclusive.

Unless otherwise stated, the potentials (in Volt) in the present description and drawings are given versus Ca²⁺/Ca. Potentials are measured by a potentiostat versus a Quasi Reference Electrode. Typically ferrocene or similar internal standard such as cobaltocene is used. Use of ferrocene is known to be suitable for works in non-aqueous media.

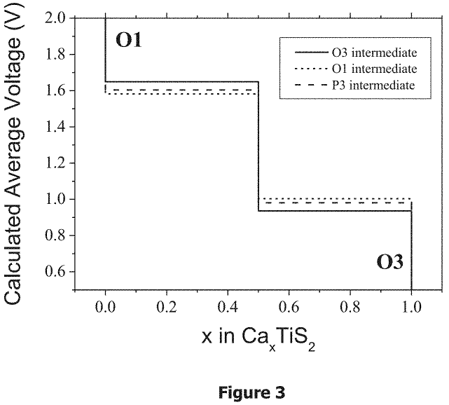

In addition to the above provisions, the invention also comprises other provisions which will become clear from the description which follows, which refers to examples evaluating calcium-based secondary battery comprising calcium-based secondary cell according to the invention, as well as FIGS. 3 to 7.

### EXAMPLES

### Example 1

### DFT Calculated Voltage

The calculations have been performed using the ab-initio total-energy and molecular dynamics program VASP (Vienna Ab-initio Simulation Program) developed at the Universität Wien. Total energy calculations based on Density Functional Theory (DFT) were performed within the General Gradient Approximation (GGA), with the exchange and correlation functional form developed by Perdew, Burke, and Ernzerhof (PBE) with adapted Van der Waals potentials (Opt-B86). The interaction of core electrons with the nuclei is described by the Projector Augmented Wave (PAW) method. The energy cut off for the plane wave basis set was kept fix at a constant value of 600 eV throughout the calculations. The integration in the Brillouin zone is done on an appropriate set of k-points determined by the Monkhorts-Pack scheme. A convergence of the total energy close to 10 meV per formula unit is achieved with such parameters. All crystal structures were fully relaxed (atomic positions, cell parameters and volume). The final energies of the optimized geometries were recalculated so as to correct the changes in the basis set of wave functions during relaxation.

Calculated voltage-composition profile (see FIG. 3) is constructed considering the total energies of the O1-TiS₂ structure and the O3-CaTiS₂ structure. For the intermediate Ca_{0.5}TiS₂, we considered the total energy of the most stable structures within the O3 structure (from a set of 9 configurations in a Ca₃Ti₆S₁₂ supercell), the P3 structure (from a set of 11 configurations in a Ca₂Ti₄S₈ supercell), and O1 structure (from a set of 3 configurations in a CaTi₂S₄ supercell).

### Example 2

### DFT Calculated Diffusion Barrier

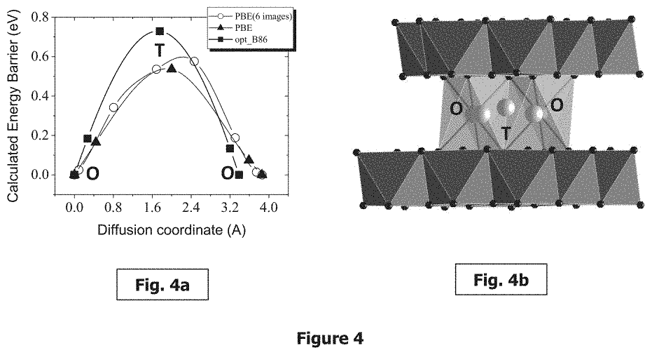

Ca²⁺ mobility in TiS₂ is investigated assuming the initial occupation of an octahedral site (O1 structure). The simplest Ca²⁺ diffusion mechanism would imply the jump of a Ca²⁺ ion to an empty neighboring site, across a tetrahedral site (see path representing in FIG. 4b). DFT calculations are performed using the Nudged Elastic Band method (NEB) as implemented in VASP. We considered a 3×3×2 CaTi₁₈S₃₆ supercell, where one Ca site is inserted in a vacant octahedral site. Constant volume calculations were performed for three intermediate images. To calculate the energy at the saddle point, cubic splines were fit through the images along each hop. The calculated the barrier using different approximations is of the order of 0.8 eV (see FIG. 4a).

### Example 3

### Ca/TiS₂ Full Cell

Synthesis of TiS₂ Positive Material:

A commercial TiS₂ material (titanium (IV) disulfide, 99.9%, Sigma Aldrich 333492) was used. This material presents a lamellar crystalline structure with micrometric particle sizes.

Electrode Preparation:

Disk electrodes were produced by coating slurry on aluminum foil. The slurry is prepared by mixing active material, Csp carbon as electronic conductor and PVDF in a weight ratio of 80/10/10 (2 g TiS₂ mixed with 0.25 g carbon black (Super P®) and 2 g of 10% solution of PVDF in NMP). To achieve the right viscosity, NMP is added as long as the slurry exhibits a flow. At first, mixing is done by means of ball milling in an agate container with three agate balls of 1 cm of diameter at 500 rpm for 2 hours, with change of the rotating way every 30 minutes using a PM100 Retsch planetary Ball Miller.

The slurries were tape cast on a 20 μm thick aluminum foil (Goodfellow) with a 400 μm Doctor-Blade and dried at 120° C. under vacuum for 2 hours. Once dried, 1 cm² disk electrodes were cut and pressed at 8 tons prior to testing.

Battery Assembly:

Three electrode Swagelok cells were used for the electrochemical tests.

Self-made calcium discs are used both as reference and counter electrode. Therefore, calcium grains (Alfa Aesar, redistilled 99.5%) were pressed to a pellet of 1 cm in diameter and app. 1 mm height using a die and a hydraulic press. This process is done in air. Within a glovebox (H₂O<0.5 ppm, O₂<0.5 ppm) the passivation layer is removed by scratching using a spatula.

Aluminum current collector is used for the positive electrode, stainless steel for the counter and reference electrodes.

The cells are assembled inside the glovebox using 500 μl of electrolyte. Two sheets of Whatman® Grade GF/D borosilicate glass fiber were used as separator.

Battery Testing:

Said electrodes (typical loading ca. 2 mg of active material) were used for galvanostatic cycling with potential limitation (GCPL) tests at 100° C. 5 hours were used to let the open circuit voltage (OCV) stabilize after placing the cell into the temperature chamber. GCPL was performed at a C/100 rate.

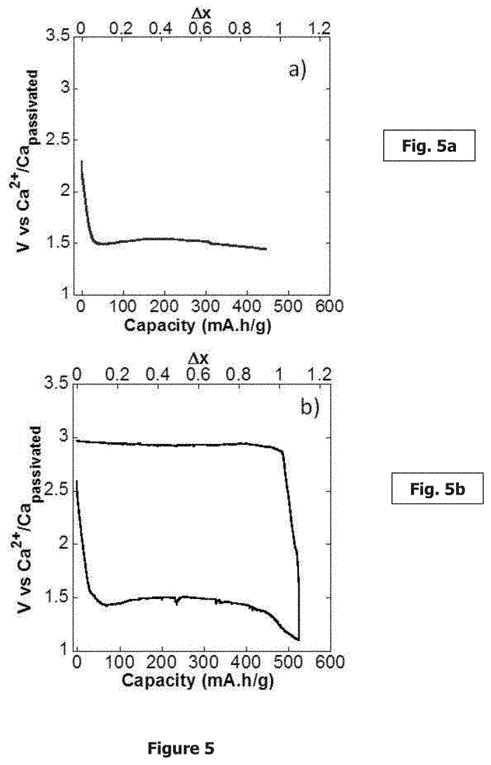

FIG. 5 represents the first discharge and charge of TiS₂ coated electrode. The test was performed at 100° C. using a Ca counter electrode in 0.45 M Ca(BF₄)₂ in EC:PC electrolyte from Solvionic.

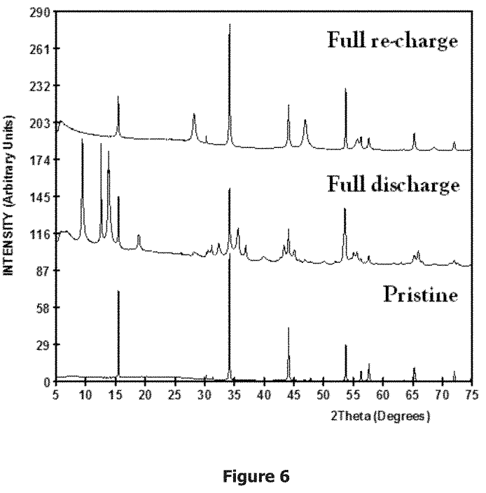

FIG. 6 represents the X-Ray diffractions (XRD) of the pristine (initial) TiS₂ based electrode, of the same electrode after discharge, and of the same electrode after recharge. A clear change of structure is observed during discharge. It is also obvious that the structure returns to its initial state after charge, confirming that the structure accommodate reversibility the ions. The extra peaks observed at 2θ (in degrees) 28.2, 46.9, 55.7 and 68.6° for the fully discharged and charged sample correspond to CaF₂ produced due to partial electrolyte decomposition and electrode passivation.

### Comparative Example 1

A Ca/V₂O₅ full cell was prepared, assembled and tested under the same conditions as described in Example 3. The electrode was prepared as described in Example 3, by replacing TiS₂ by V₂O₅. The obtained full cell is representative of the prior art 1 (WO 2016/050331).

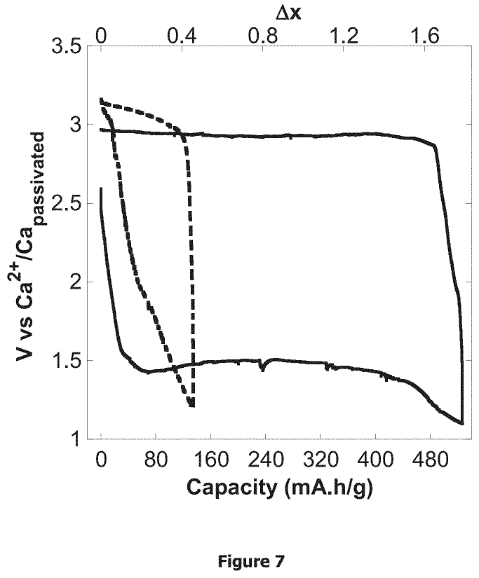

FIG. 7 represents the 1^{st} cycle (charge and discharge) of the full Ca/V₂O₅ cell prepared above (in dotted lines), compared to the 1^{st} cycle of Ca/TiS₂ full cell of Example 3 already shown in FIG. 5. The test was performed at 100° C. using a Ca counter electrode in 0.45M Ca(BF₄)₂ in EC:PC electrolyte from Solvonic.

V₂O₅ is used as a reference tested in the same conditions as TiS₂ in order to demonstrate the advantages of the cell of the invention in terms of higher potential, higher experimental capacity, and better rechargeability. Indeed, it is clear from FIG. 7 that TiS₂ presents a higher experimental capacity than V₂O₅.

Comparison with Prior Art Materials:

The following table (Table 1) summarizes properties of the rechargeable batteries described in the present invention as compared to the ones disclosed in the following prior art references discussed above:
Prior art 1: WO 2016/050331,
Prior art 2: M. Cabello et al., Electrochemistry Communications 67 (2016) 59-64,
Prior art 3: Ph.D. thesis of J. Rogosic entitled “Towards the Development of Calcium Ion Batteries” (MIT, 2014),
Prior art 4: Hayashi et al., Journal of Power Sources 119-121 (2003), 617-620, and
Prior art 5: A. L. Lipson et al., Chemistry of Materials, 2015, 27 (24), pp. 8442-8447.

TABLE 1

| | | | | Theoretical | Experimental | | |
|---|---|---|---|---|---|---|---|
| | | | | capacity of | capacity of | Experimental | |
| | | Molar | | positive | positive | average | |
| | | weight of | | material | material | operation | |
| | | positive | | (mAh/g- | (mAh/g- | voltage of | |
| Type of | Positive | material | Negative | positive | positive | full battery | Operation |
| battery | material | (mol/g) | material | material) | material) | (V) | temperature |
| Battery | TiS₂ | 112.012 | Ca | 478 | 478 | 2.25 | 30° C. ≤ |
| type 1 of | | | | | | | T ≤ 150° C. |
| present | | | | | | | |
| invention | | | | | | | |
| Prior art 1 | V₂O₅ | 182 | Ca | 295 | NA | NA | 100° C. |
| Prior art 2 | CaCo₂O₆ | 222 | V₂O₅ | 241 | 100 | 0.9 | Room |
| | | | | | | | temperature |
| Prior art 3 | Chevrel phases | 600.84 | CaHg₁₁—CaHg | 89 | 13 | 1.25 | Room |
| | Mo₃Se₄ | | | | | | temperature |
| Prior art 4 | V₂O₅ | 182 | Ca | 295 | 400 | NA | Room |
| | | | | | | | temperature |
| Prior art 5 | MCFN: | 267 | CaSn | 201 | 87 | 1.25 | Room |
| | MnFe(CN)₆ | | | | | | temperature |

NA = not applicable

Theoretical capacity is calculated with the following formulae:

Q_{theoretical}=(96500/3600)×(n/M)×1000

with: n the number of electrons exchanged, and
M the molar weight of positive material (in mol·g⁻¹).

1. A calcium-based secondary cell comprising:
a negative electrode that includes a negative-electrode active material, said negative-electrode active material being capable of accepting and releasing calcium ions,
a positive electrode that includes a positive-electrode active material, said positive-electrode active material being capable of accepting and releasing calcium ions,
an electrolyte arranged between the negative electrode and the positive electrode, said electrolyte comprising calcium ions dissolved in at least one solvent,
a temperature control element able to set the operating temperature of the cell from 30 to 150° C.,
wherein the positive-electrode active material is one or more titanium-based materials comprising at least titanium (IV) and sulfide.

2. The cell according to claim 1, wherein the titanium-based material is of general formula CaₓL_{y}TiS₂ wherein 0≤x≤1, 0≤y≤6, and L is a solvent molecule.

3. The cell according to claim 2, wherein the titanium-based material of general formula CaₓL_{y}TiS₂ comprises calcium species CaₓL_{y} intercalated within the TiS₂ material.

4. The cell according to claim 1, wherein the titanium-based material is of general formula CaₓTiS₂ wherein 0≤x≤1.

5. The cell according to claim 4, wherein the titanium-based material of general formula CaₓTiS₂ comprises calcium species Caₓ intercalated within the TiS₂ material.

6. The cell according to claim 1, wherein the titanium-based material is TiS₂.

7. The cell according to claim 1, wherein the titanium-based material is selected from the group consisting of: TiS₂ (O1 structure), CaTiS₂ (O3 structure), CaₓTiS₂ wherein 0<x<1 (O1, O3 or P3 structure), and mixtures thereof.

8. The cell according to claim 1, wherein the titanium-based material presents an activation energy for calcium ions migration of around 0.8 eV, and an estimated diffusion coefficient for calcium ions that is higher than 10⁻¹⁷ cm²·s⁻¹ at room temperature.

9. The cell according to claim 1, wherein the negative electrode material is a calcium metal anode or a calcium alloy anode, and preferably a calcium metal anode.

10. The cell according to claim 1, wherein the electrolyte comprising calcium ions is chosen from Ca(BF₄)₂, Ca(ClO₄)₂, Ca(PF₆)₂, Ca(TFSI)₂, Ca(Tf)₂, Ca(CF₃SO₃)₂, and mixtures thereof.

11. The cell according to claim 10, wherein the electrolyte contains Ca(BF₄)₂, when the titanium-based material is CaₓTiS₂.

12. The cell according to claim 1, wherein the solvent is chosen from ethylene carbonate (EC), propylene carbonate (PC), dimethyl carbonate (DMC), butylene carbonate (BC), vinylene carbonate (VC), fluoroethylenecarbonate (FEC), vinylene carbonate (VC), and fluoroethylenecarbonate (FEC), and mixtures thereof, and preferably from ethylene carbonate (EC), propylene carbonate (PC), dimethyl carbonate (DMC), and mixtures thereof.

13. A method for operating a calcium-based secondary cell according to claim 1, said method comprising the step of setting cell operating temperature from 30° C. to 150° C.

14. The method according to claim 13, wherein the step of setting cell operating temperature comprises a temperature control element.

15. The method according to claim 13, said method comprising the step of applying a voltage from 0.6 to 2.5 V, for intercalating calcium ions in the titanium-based material.

16. A non-aqueous calcium-based secondary battery comprising a calcium-based secondary cell according to claim 1.

17. A vehicle, an electronic device or a stationary power generating device comprising a non-aqueous calcium-based secondary battery according to claim 16.
